(19) United States
(12) Patent Application Publication
(10) Pub. No.: US 2014/0097988 A1
(43) Pub. Date: Apr. 10, 2014

(54) SPEED ESTIMATION USING DELTA RTT MEASUREMENTS AND AREA MAPS

(71) Applicant: QUALCOMM Incorporated, San Diego, CA (US)

(72) Inventor: Stephen Joseph BEAUREGARD, Santa Clara, CA (US)

(21) Appl. No.: 13/646,276

(22) Filed: Oct. 5, 2012

(51) Int. Cl. G01S 11/04

(52) U.S. Cl. CPC G01S 11/04
USPC 342/461

(57) ABSTRACT

Systems and methods for two-dimensional (2D) velocity estimation of an object in an area of interest are disclosed. The area of interest can correspond to an indoor or an outdoor environment. Round trip times (RTTs) of signals from two or more signal sources to the object are determined. The object is relocated and delta RTT values of the signals subsequent to relocation of the object within the area of interest are determined. Angles of arrival (AOAs) of the signals at the object also determined. The 2D velocity of the object is estimated by on solving a system of non-linear equations based on the delta RTT values and the AOAs.

### FIELD OF DISCLOSURE

Disclosed embodiments are directed to localization and speed estimation. More particularly, exemplary embodiments relate to two-dimensional (2D) velocity estimation of objects/particles in an area of interest using one-dimensional (1D) speed estimates based on delta round trip time (RTT) and angle of arrival (AOA) of signals from known signal sources to the objects/particles.

### BACKGROUND

Tracking of objects and persons plays a crucial role in various situations. For example, localization and 2D speed estimation of an object within a building may provide important information relevant to monitoring security of the building. Such applications may also be relevant in contexts which are not indoor, but may correspond to outdoor environments such as an open air stadium.

One approach to localization involves the use of WiFi signal strength measurements, wherein a known set of WiFi signal strength fingerprints from various base stations are used to map an object's fingerprint to coordinates within an area of interest. Received signal strength indication (RSSI) measurements and particle filters (PFs) in conjunction with maps, such as building floor plans, are conventionally used in WiFi localization techniques to constrain movement of particles in simulation models, for example based on Monte Carlo methods. PFs are conventionally used in determining state space distribution of variables or particles in such simulation models, and with constraining the particles appropriately, can lead to estimation of their location in the context of localization. However, these methods are insufficient to accurately predict 2D velocity of a particle's position propagation.

As a consequence, the above conventional methods are also deficient in being able to predict turn rates which may provide useful information regarding propagation of particles, for example, around corners. Additionally, inertial sensors such as accelerometers, gyro meters, and magnetometers may be required in order to estimate information pertaining to such movement of particles, which incurs significant costs. Some known solutions may also utilize customized beacons, such as ultra-wide band (UWB), radio frequency (RF) ultrasound, active RFID tags etc. Moreover, it may not be feasible to deploy such additional equipment due to various constraints inherent to particular environments.

Therefore the PFs in dynamical models, which are used for movement estimation, lack sufficient information to be able to accurately estimate 2D velocity of particles. As a consequence, they rely on default models which assume a random walk behavior, which may optionally involve a tunable velocity noise factor.

Other known approaches for estimating 2D velocity may involve complex motion estimation models, which may be configured to account for individual movement states of each particle. For example, these motion estimation models may incorporate pedestrian motion modeling for step length and step direction estimation and movement states such as stopped/moving, constant velocity/coordinated turn, etc. in arriving at a 2D velocity estimate. However, these complex motion estimation models require a large number of tuning parameters which may need to be tuned in advance or estimated in real time in order to arrive at 2D velocity estimation. As a result, these complex motion estimation models may also be prohibitively expensive and unfeasible in many environments where 2D velocity estimation may be desired.

Both the PF dynamical models and the complex motion estimation models described above additionally suffer from a high degree of noise contamination. The noise contamination of 2D velocity estimations arises because the effective result of 2D velocity estimations in these models does not involve a direct measurement of motion behaviors or state of the particles or object of interest. Accordingly, these motion models need to include a large amount of noise in order to explore the hypothesis state space to a reasonable degree of completeness. Moreover, a very large particle count, in the order of hundreds of thousands of particles may be required for these conventional estimation models to work, which leads to these models being computationally expensive.

Accordingly, there is a need in the art for avoiding the aforementioned drawbacks of conventional approaches and providing low cost and accurate solutions for 2D velocity estimation of objects within an area of interest.

### SUMMARY

Exemplary embodiments of the invention are directed to systems and method for 2D velocity estimation of objects in an area of interest. The area of interest may correspond to an indoor environment or an outdoor environment.

For example, an exemplary embodiment is directed to a method of two-dimensional (2D) velocity estimation of an object located in a first area, the method comprising: determining round trip times (RTTs) of signals from two or more signal sources to the object, determining delta RTT values of the signals subsequent to relocation of the object within the first area, based at least in part on the determined RTTs, determining angles of arrival (AOAs) of the signals at the object, and calculating a 2D velocity estimate based on the delta RTT values and the AOAs.

Another exemplary embodiment is directed to an apparatus comprising: a receiver configured to receive signals, logic to determine round trip times (RTTs) of signals to an object located in a first area from two or more signal sources, logic to determine delta RTT values of the signals to the object based at least in part on a relocation of the object within the first area and the determined RTTs, logic to determine angles of arrival (AOAs) of the signals at the object, and logic to calculate a 2D velocity estimate of the object based on the delta RTT values and the AOAs.

Another exemplary embodiment is directed to a system comprising means for determining round trip times (RTTs) of signals from two or more signal sources to an object located in a first area, means for determining delta RTT values of the signals subsequent to relocation of the object within the first area, based at least in part on the determined RTTs, means for determining angles of arrival (AOAs) of the signals at the object, and means for calculating a 2D velocity estimate of the object based on the delta RTT values and the AOAs.

Yet another exemplary embodiment is directed to a non-transitory computer-readable storage medium comprising code, which, when executed by a processor, causes the processor to perform operations for estimating two-dimensional (2D) velocity of an object located in a first area, the non-transitory computer-readable storage medium comprising code for determining round trip times (RTTs) of signals from two or more signal sources to the object, code for determining delta RTT values of the signals subsequent to relocation of the object within the first area, based at least in part on the determined RTTs, code for determining angles of arrival (AOAs) of the signals at the object, and code for calculating a 2D velocity estimate based on the delta RTT values and the AOAs.

Another exemplary embodiment is directed to a method for speed estimation comprising determining at least two linearly-independent one dimensional (1D) speed measurements based on signals from a plurality of access points (APs), measuring angles of arrival (AOAs) for each of the signals, and calculating a two dimensional (2D) velocity estimate using the at least two linearly-independent 1D speed measurements and the AOAs for each of the signals.

### BRIEF DESCRIPTION OF THE DRAWINGS

The accompanying drawings are presented to aid in the description of embodiments of the invention and are provided solely for illustration of the embodiments and not limitation thereof.

FIG. 1A illustrates an exemplary embodiment for computing 2D velocity estimate of an object in area 100, based on RTT and AOA from signals to the object from three signal sources.

FIG. 1B illustrates an exemplary embodiment for computing 2D velocity estimate of an object in area 100, based on RTT and AOA from signals to the object from three signal sources, wherein the object is located at a certain height from the ground.

FIG. 1C illustrates an embodiment depicting variables for calculating delta RTT and AOA information for an object located at a test point according to an exemplary algorithm.

FIG. 2 illustrates an embodiment directed to modifying aspects of FIGS. 1A-1C wherein a path to the object from one or more of the signal sources are obstructed.

FIGS. 3A-B are flow chart depictions of exemplary methods of computing 2D velocity estimates in an area of interest.

FIG. 4 illustrates an exemplary wireless communication system 104 in which an embodiment of the disclosure may be advantageously employed.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Exemplary embodiments include low cost solutions for estimating 2D velocity in areas of interest which may include indoor or outdoor environments. Exemplary embodiments may avoid aforementioned complexities of conventional solutions associated with the need for inertial sensors, customized beacons, etc. Further, embodiments may also remain unaffected by problems such as spurious movements (e.g. juggling of a cell phone or loitering, fidgeting motions), which may be associated with complex motion modeling based on pedestrian motion state estimation.

For example, in some embodiments, WiFi access points (APs) or signal sources capable of computing round trip time (RTT) and/or delta RTT may be deployed at selected positions within an environment wherein 2D velocity estimation is desired. As will be explained in detail in the following sections, delta RTT measurements to the signal sources may provide 1D speed estimates of a desired test point. Known positions of the signal sources may be used to compute angle of arrival (AOA) of signal rays at the test point. The 1D speed estimate may be combined with the AOA information in order to generate accurate 2D velocity estimates. In some embodiments, an object as described below, for example an object comprising a mobile device, may be capable of computing round trip time (RTT) and/or delta RTT.

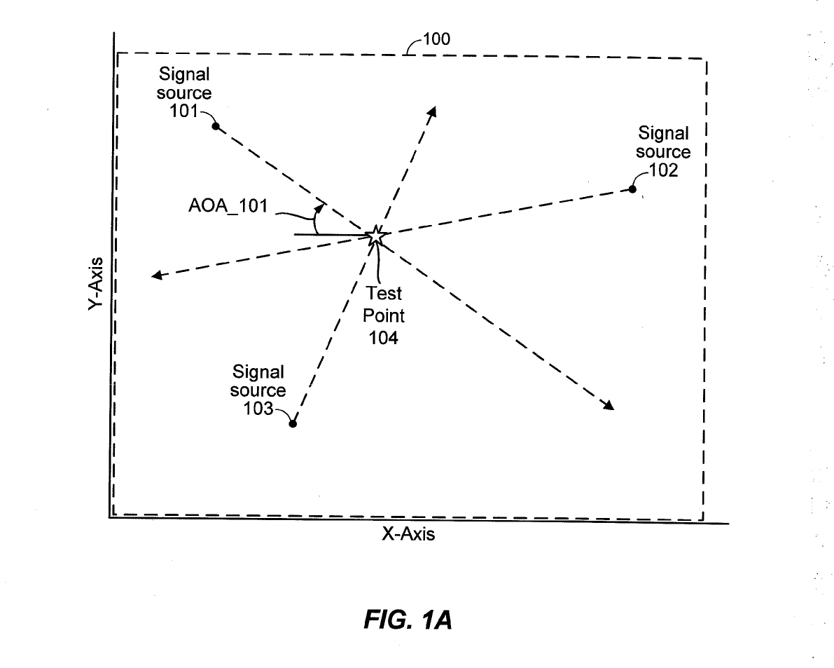

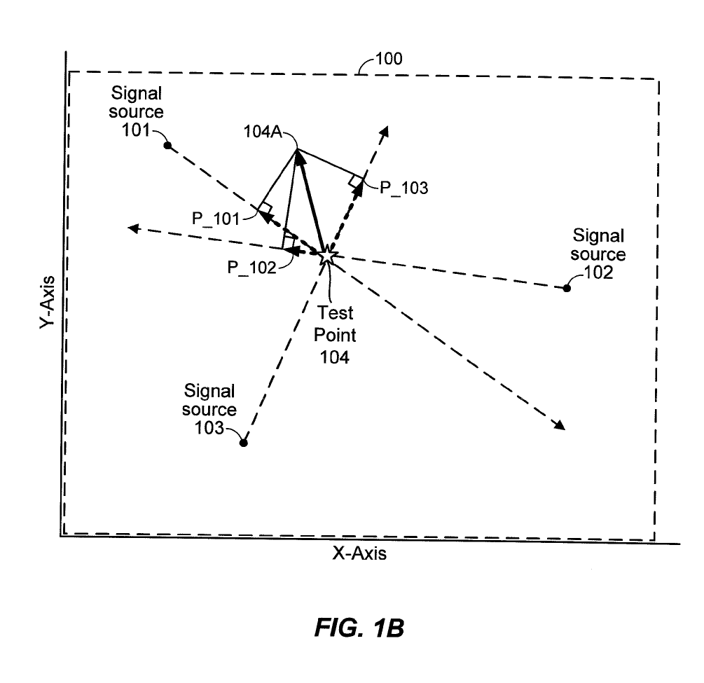

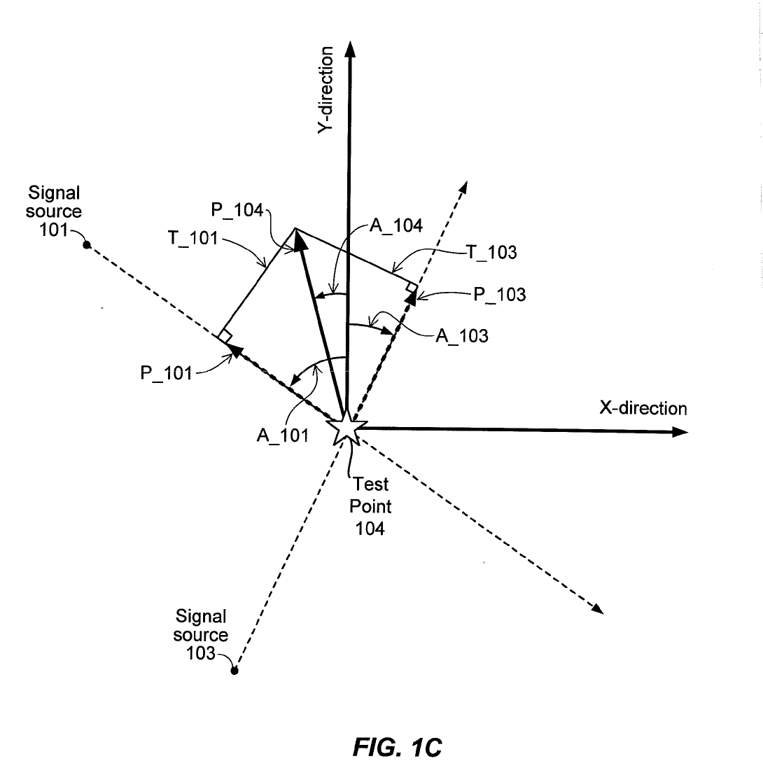

With reference now to FIG. 1A, an exemplary 2D area 100 is illustrated wherein embodiments for calculating 2D velocity may be deployed. Area 100 may correspond to an indoor environment or an outdoor location. In selected coordinates of area 100, three APs or signal sources 101-103 are placed. Test point 104 may correspond to a first location within area 100 and may comprise a particle or object in motion. In this description, the term “test point” may be used interchangeably with the particle or object situated at the test point. As depicted, signals from all three signal sources 101-103 converge at test point 104. For ease of understanding, FIG. 1A illustrates all three signal sources 101-103 and test point 104 as positioned at the same height, for example, on the ground level of the building, in the context of an indoor environment.

An angle of arrival (AOA) to test point 104 from each of the three signal sources 101-103 (e.g. AOA_101 illustrated for signal source 101) can be calculated using simple trigonometry. As previously mentioned, RTT from each of the three signal sources 101-103 to test point 104 may be obtained. In some embodiments, these AOA and RTT values for each signal source 101-103 can be calculated ahead of time for each point on area 100. These values may be stored in a database located on a server and accessible by the signal sources. In some embodiments, the database may be located at or accessible by a handheld or mobile device situated at test point 104. Regardless of how and where these values are stored, AOA and RTT heatmaps may be provisioned with RTT information for each point on area 100 and for each of the three signal sources 101-103. Thus, the AOA and RTT information for test point 104 may be determined from these heatmaps, for example, by looking up the database using the location of test point 104.

Once the AOA and RTT values for test point 104 are determined, these values may be utilized for computation of 2D velocity estimate based on particular implementation models in exemplary embodiments. For example, in one embodiment, test point 104 may include a wireless or mobile device, and the AOA and RTT values for the particular location of test point 104 may be transmitted to the mobile device from a server comprising the database. In some embodiments, the database may be present in the mobile device, for example, in a compact vector representation, and the AOA and RTT values can be looked up locally by the mobile device. In embodiments using PFs for a dynamic motion estimation model, the AOA and RTT values may be associated with a particle located at test point 104, and these values may be used in modeling and estimating 2D velocity for the particle, for example, by utilizing a computer or processing device which may be located anywhere. Accordingly, embodiments can avoid the use of complex motion estimation models, or additional equipment such as accelerometers, gyro meters, and magnetometers, UWB, RF ultrasound, active RFID tags etc. for calculating the 2D velocity. In some embodiments, however, this additional equipment is used in combination with the embodiments described herein to calculate velocity. Those of skill in the art will appreciate that certain embodiments described herein may incur significantly lower costs in comparison to conventional techniques for calculating 2D velocity.

Regardless of how the AOA and RTT for each of the three signal sources 101-103 are determined for test point 104, once this information is obtained, the object or particle at test point 104 may be propagated to a second location in area 100, referred to herein as test point 104′ (not shown in the figure), based on this information or due to physical movement of the object, for example. In some embodiments, a user of the object may have relocated the object. The difference in RTT for each signal source 101-103 between the first and second locations, or test points 104 and 104′, may be derived from the above described heatmap in one embodiment. This difference is referred to as delta RTT, and corresponds to 1D speed. By repeating this process over numerous test points, a delta RTT mean (i.e. 1D speed) and corresponding variance to each signal source 101-103 can be calculated.

Turning now to FIG. 1B, an object at test point 104 is illustrated as present at a certain height from ground level at point 104A. The remaining elements of FIG. 1A remain substantially unchanged in FIG. 1B. The technique for estimation of 2D velocity for test point 104 may be substantially similar to the one described above with reference to FIG. 1A, with one notable difference in that projections P_101, P_102, and P_103 may be used in AOA and RTT computations. As shown, P_101, P_102, and P_103 are projections of point 104A in the directions of signal sources 101-103 respectively. As test point 104 at height 104A moves along area 100, the set of projection points will also move. At each instance, the projection points may be used to look up or compute RTT and AOA values. For example, at the illustrated instance, instead of using test point 104 for looking up or computing RTT and AOA with respect to signal source 101, projection point P_101 may be used. Similarly for the other signal sources.

Once the delta RTT variance is available, the AOA for test point 104 and for each signal source 101-103 can be obtained, for example, from the corresponding heatmap. The 2D velocity of test point 104 can then be estimated using the below algorithms in order to obtain delta RTT variance and AOA information. Test point 104 may then be propagated forward in time using the estimated 2D velocity.

With reference now to FIG. 1C, an exemplary algorithm for calculating delta RTT and AOA information for an object located at test point 104 (which may be located at a height 104A as in FIG. 1B) is illustrated. Without loss of generality, the X and Y directions are shown centered at the point of interest, test point 104 for ease of explanation. The desired 2D velocity of the projection P_104 of test point 104 on the X-Y plane is hereinafter referred to as “\hat{v}”. For clarity of illustration, only the projection points with regard to two signal sources, 101 and 103 are shown in FIG. 1C, while the projection points with regard to signal source 102 has been omitted. Accordingly, the two right-angled triangles T_101 and T_103 corresponding to projections P_101 and P_103 relative to the signal sources 101 and 103 will be considered in the following formulation of deriving the 2D velocity \hat{v} of test point 104 on the X-Y plane.

In this disclosure, angles made by the various projections on the X-Y plane are considered to be zero in the Y direction, while they are depicted to be increasing in the counterclockwise direction. Following this notation, the angles of arrivals (AOAs) A_104, A_101, and A_103 of FIG. 1C will hereinafter be referred to as θ_{\hat{v}}, θᵥ_{₁}, and θᵥ_{₃} respectively. The magnitude of the 1D velocity, or speed, as obtained from the delta RTT, of projections P_101 and P_103 will be referred to hereinafter as ∥v₁∥ and ∥v₃∥ respectively. Similarly, for P_104, the magnitude of \hat{v}, will be referred to as ∥\hat{v}∥. The 2D velocity can be obtained by calculating the magnitude ∥\hat{v}∥ and corresponding direction or AOA θ_{\hat{v}}. In order to calculate the magnitude ∥\hat{v}∥ and AOA θ_{\hat{v}}, embodiments may rely on the relationship that ∥\hat{v} is (approximately) equal to the perpendicular projection of every measured speed, such as, ∥v₁∥ and ∥v₃∥ onto the vector \hat{v}. In mathematical terms, this relationship obtained from triangle T_101 can be expressed by the equation,

$$\begin{matrix}‖ {v}_{1} ‖ = ‖ \hat{v} ‖ cos ( {θ}_{{v}_{1}} - {θ}_{\hat{v}} ) \\ = ‖ \hat{v} ‖ [ cos ( {θ}_{{v}_{1}} ) cos ( {θ}_{\hat{v}} ) + sin ( {θ}_{{v}_{1}} ) sin ( {θ}_{\hat{v}} ) ]\end{matrix}$$

A similar relationship can be formulated for triangle T_103. Generalizing these formulations for n signal sources, wherein n is at least 2, the following system of non-linear equations comprising speed and corresponding AOAs corresponding to respective signal sources can be obtained:

$$[ \begin{matrix}‖ {v}_{1} ‖ \\ ⋮ \\ ‖ {v}_{n} ‖\end{matrix} ] = ‖ \hat{v} ‖ [ \begin{matrix}cos ( {θ}_{{v}_{1}} ) cos ( {θ}_{\hat{v}} ) & sin ( {θ}_{{v}_{1}} ) sin ( {θ}_{\hat{v}} ) \\ ⋮ & ⋮ \\ cos ( {θ}_{{v}_{n}} ) cos ( {θ}_{\hat{v}} ) & sin ( {θ}_{{v}_{n}} ) sin ( {θ}_{\hat{v}} )\end{matrix} ]$$

In the above system of non-linear equations, the speeds ∥v₁∥ . . . ∥vₙ∥ based on corresponding delta RTT values, as well as, AOAs θᵥ_{₁}, . . . θᵥ_{ₙ} can be obtained as previously described, and therefore, these are known quantities in the equations. Thus, the unknown quantities, ∥\hat{v}∥ and θ_{\hat{v}} can be estimated using well known methods such as the Levenberg-Marquardt algorithm (also known as the damped least-squares method) or the Scaled Conjugate Gradients algorithm. In some embodiments, an estimated noise of each speed measurement vₙ can be used to set a weight to each corresponding speed measurement when solving the above system of non-linear equations. One of ordinary skill in the art will recognize suitable alternative methods to calculate the 2D velocity of a test point of interest without departing from the scope of the embodiments.

Returning to FIGS. 1A-B, signal sources 101-103 have been described as having an unobstructed path to test point 104 in area 100. However, this may not necessarily be the case, and in some instances, signal sources or APs may be obstructed. For example, APs may be present in a different room of a building, with walls obstructing the path to the area of interest where a test point is present.

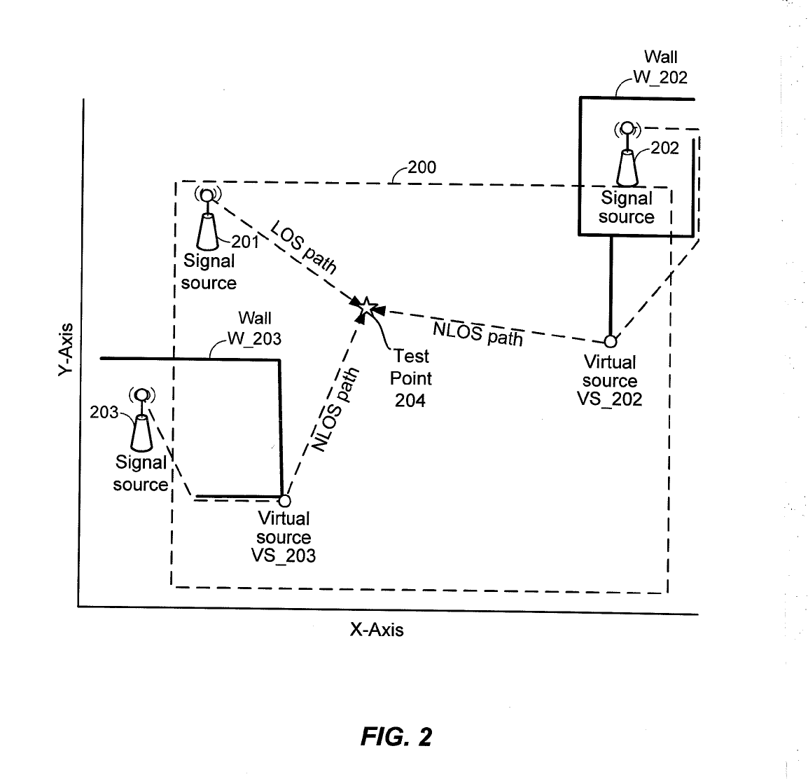

Referring now to FIG. 2, an exemplary embodiment directed to 2D velocity estimation with APs or signal sources which may be obstructed by walls (or other obstructions) is illustrated. As shown, test point 204 is present in an area that is generally designated as 200. Three APs or signal sources 201-203 are illustrated. While signal source 201 is shown to be in a line of sight (LOS) unobstructed path to test point 204, both signal sources 202 and 203 are shown to be obstructed by walls W_202 and W_203 respectively. Accordingly these signal sources 202 and 203 have a non LOS (NLOS) path to test point 104.

In order to account for the obstruction due to walls W_202 and W_203, a dominant path model (DPM) may be used wherein a list of LOS segments between a signal source and all test points in area 200 are calculated in initial conditions. The last of these segments in the list for a test point of interest is treated as an LOS path between the test point and a last corner for the particular signal source. A virtual source is assumed to be present in this last corner. For example, with regard to test point 204, a list of LOS segments to signal source 202 is used to determine virtual signal source VS_202. This virtual signal source VS_202 replaces signal source 202 in estimations or computations for RTT and/or AOA with respect to test point 204. Similarly, virtual signal source VS_203 is determined for signal source 203, and thereafter, virtual signal source VS_203 is used in estimations or computations for RTT and AOA with respect to test point 204. Because signal source 201 is already in a LOS path to test point 204, a virtual signal source determination is not required in this case. Using signal source 201, and virtual signal sources VS_202 and VS_203, the estimation of 2D velocity may be performed in a manner that is substantially similar to the description provided above with regard to signal sources 101-103 in FIGS. 1A-B in conjunction with FIG. 1C above.

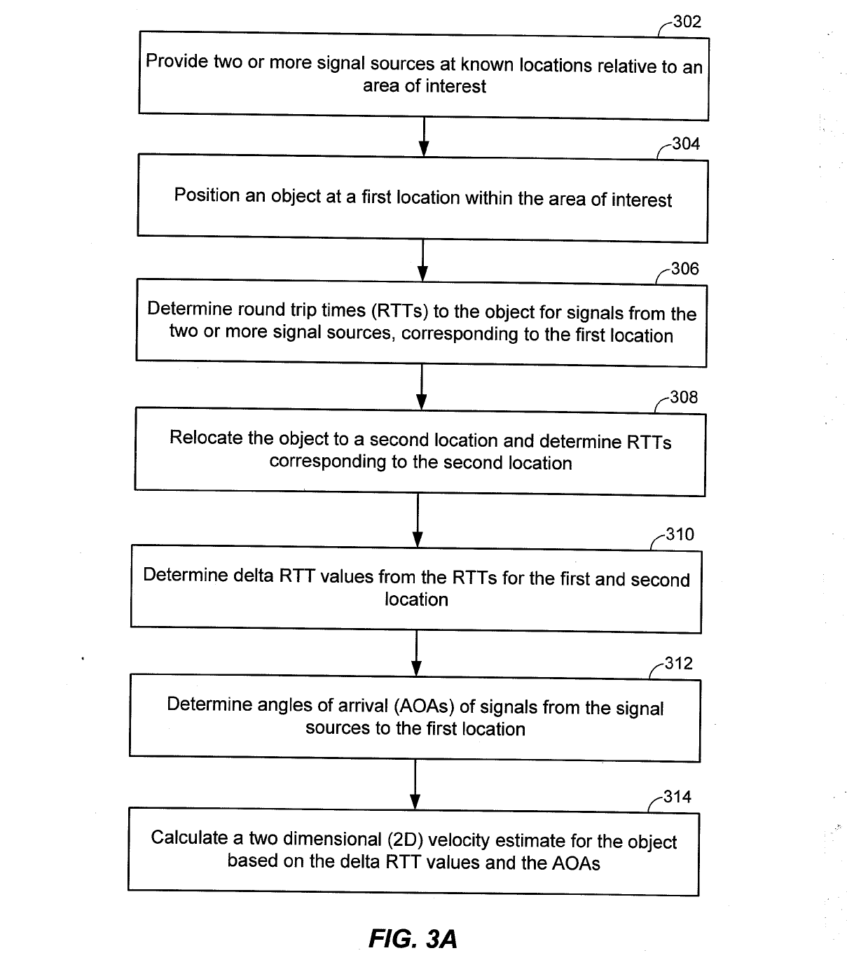

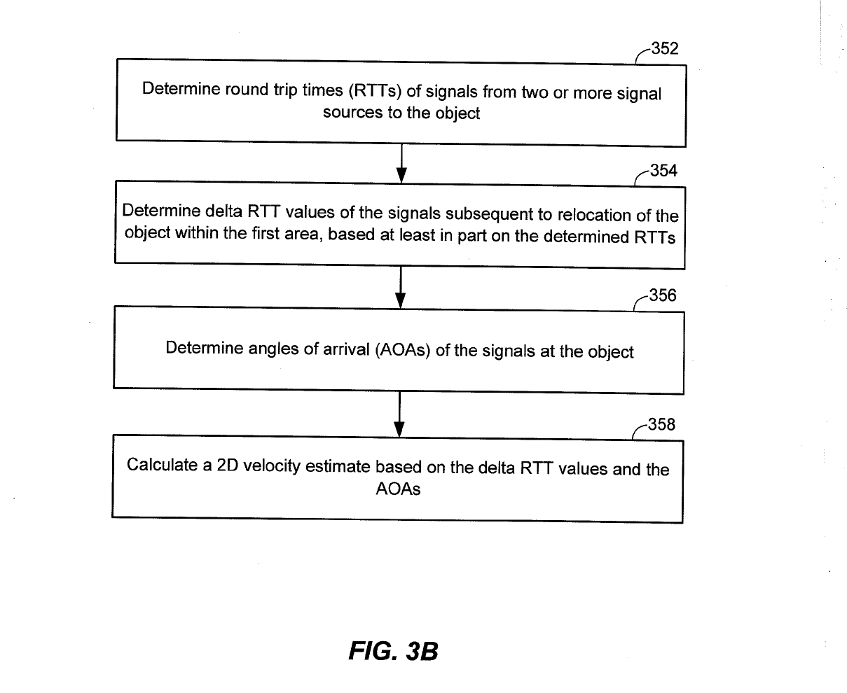

It will be appreciated that embodiments include various methods for performing the processes, functions and/or algorithms disclosed herein. For example, as illustrated in FIG. 3A, an embodiment can include a method of two-dimensional (2D) velocity estimation of an object within an area of interest (e.g. area 100). The method may include providing two or more signal sources (e.g. signal sources 101-103) at known locations relative to the area of interest—Block 302. Initially, the object may be at a first location (e.g. test point 104)—Block 304. Round trip times (RTTs) for signals from the two or more signal sources to the object may be determined for the first location of the object (e.g. by provisioning heatmaps in advance for RTTs from each of the two or more signal sources for test points in the area of interest, storing this information in a database which may be located at a server or at a handheld device situated at the location of the object, and determining the RTTs from the database; or by measuring an amount of time elapsed when messages are communicated between the object and at least one of the two or more signal sources)—Block 306. The object can then be relocated to a second location (e.g. test point 104′) and the corresponding RTTs can be determined once again—Block 308. Using the RTTs for the first and second location, delta RTT values can be calculated—Block 310. Angles of arrival (AOAs) of signals from the two or more signal sources to the object at the first location can be determined (e.g. using trigonometric functions based on the known locations of the two or more signal sources and the location of the object. Similar to RTTs, the AOAs, such as AOA_101 for test point 104, within the area of interest may be calculated in advance and stored in a database, and the AOAs for the location of the object may be retrieved from the database. Once again, the database comprising AOAs may be located at a server or at a mobile device situated at the location of the object)—Block 312. Using the delta RTTs and the AOAs, 2D velocity of the object may be estimated (e.g. using methods such as the Levenberg-Marquardt algorithm)—Block 314.

In another example, as illustrated in FIG. 3B, an embodiment can include a method of two-dimensional (2D) velocity estimation of an object (e.g. test point 104) located in a first area (e.g. area 100), the method comprising: determining round trip times (RTTs) of signals from two or more signal sources (e.g. signal sources 101-103) to the object—Block 352; determining delta RTT values of the signals subsequent to relocation of the object (e.g. test point 104′) within the first area, based at least in part on the determined RTTs—Block 354; determining angles of arrival (AOAs) of the signals at the object—Block 356; and calculating a 2D velocity estimate based on the delta RTT values and the AOAs (e.g. using methods such as the Levenberg-Marquardt algorithm)—Block 358.

It will be understood that at least Blocks 306, 310, 312, and/or 314 illustrated in FIG. 3A or any or all of the Blocks 352-358 illustrated in FIG. 3B of the above-described methods may be performed wholly at a mobile device (e.g. if the databases pertaining to RTTs and AOAs are located at the mobile device, an associated processor may perform the 2D velocity estimates); wholly at a server (e.g. the mobile device may send location information to the server, and the RTTs, AOAs and 2D velocity computations may be performed at the server; or by utilizing a combination of the mobile device and the server (e.g. the mobile device may determine certain measurements pertaining to the RTTs and/or AOAs and transmit them to the server location, whereby the remaining method for determining 2D velocity estimates may be completed at the server).

Accordingly, an embodiment of the invention can include any means for performing the functionality described herein. For example, an exemplary embodiment for estimating 2D velocity of an object located in a first area (e.g. an indoor environment such as a building, or an outdoor environment) can include means for determining round trip times (RTTs) of signals from two or more signal sources to an object located in a first area (e.g. by utilizing a receiver included in the object, wherein the receiver is configured to receive the signals, and utilizing a database storing RTTs of locations in the first area and looking up the RTT for the object based on the location of the object within the first area; further there may be means located at one of the signal sources, such as when the signal source comprises an AP for example, or at the object, for example when the object comprises a mobile device, to determine the RTTs based on measurements of an amount of time elapsed when messages are communicated between the object and the signal source). The embodiment can further include means for determining delta RTT values of the signals subsequent to relocation of the object within the first area, based at least in part on the determined RTTs (e.g. by once again looking up the database for the RTTs corresponding to the location of the object subsequent to relocation or by calculating the RTTs based on exchanged communications). Additionally, the embodiment may include means for determining angles of arrival (AOAs) of the signals at the object (e.g. by utilizing a database for AOAs similar to the database for RTTs or by determining the AOAs based on, for example, a location of the signal source and a map or set of obstacles or signal blockers, etc.). The embodiment may further include means for calculating a 2D velocity estimate of the object based on the delta RTT values and the AOAs (e.g. a processor for solving a system of non-linear equations by employing algorithms such as the Levenberg-Marquardt algorithm).

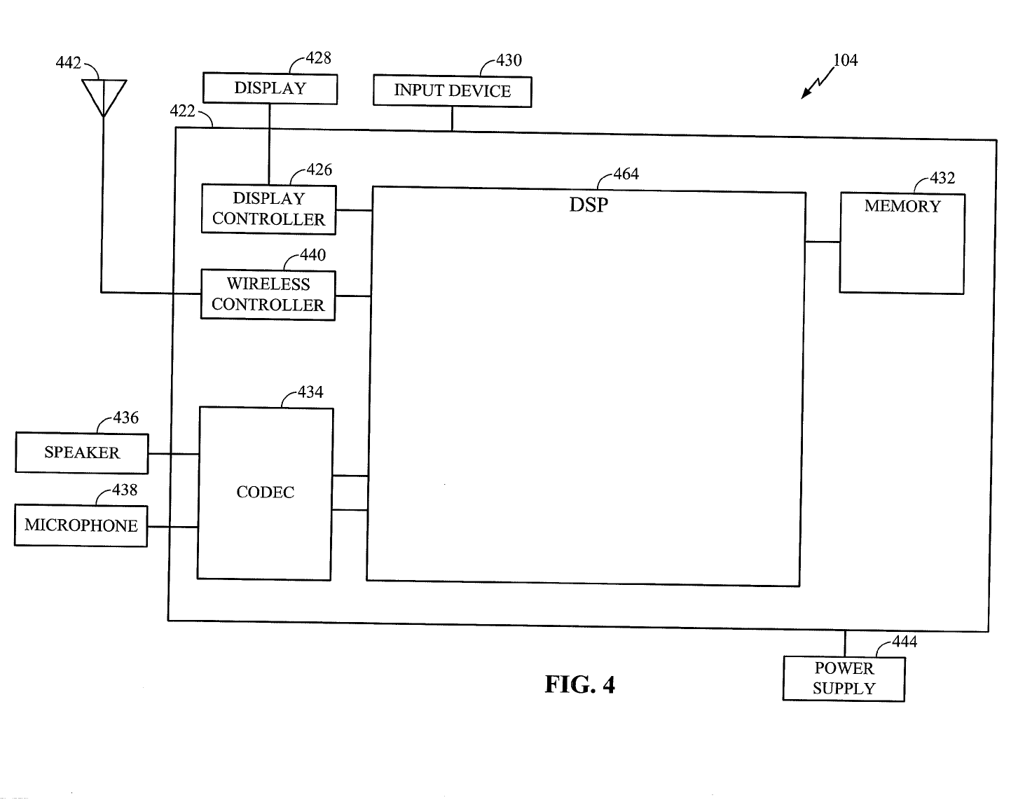

Moreover, an embodiment of the invention can include computer readable media embodying a method for 2D velocity estimation of an object. For example, an exemplary embodiment for estimating 2D velocity of an object located in a first area (e.g. an indoor environment such as a building, or an outdoor environment) can include code for determining round trip times (RTTs) of signals from two or more signal sources to an object located in a first area (e.g. by utilizing a receiver included in the object, wherein the receiver is configured to receive the signals, and wherein the object includes a computer readable medium comprising a database and code for storing RTTs of locations in the first area in the database and code for looking up the RTTs for the object from the database, based on the location of the object within the first area; further, the computer readable medium may comprise code for determining the RTTs based on measurements of an amount of time elapsed when messages are communicated between the object and the signal source). The embodiment can further include code for determining delta RTT values of the signals subsequent to relocation of the object within the first area, based at least in part on the determined RTTs (e.g. by once again utilizing code for looking up the database for the RTTs corresponding to the location of the object subsequent to relocation or by utilizing code for calculating the RTTs based on exchanged communications). Additionally, the embodiment may include code for determining angles of arrival (AOAs) of the signals at the object (e.g. by utilizing a database for AOAs similar to the database for RTTs and using code for looking up the database to obtain the AOAs for the object or by utilizing code for determining the AOAs based on, for example, a location of the signal source and a map or set of obstacles or signal blockers, etc.). The embodiment may further include code for calculating a 2D velocity estimate of the object based on the delta RTT values and the AOAs (e.g. by utilizing code for solving a system of non-linear equations by employing algorithms such as the Levenberg-Marquardt algorithm). It will be further appreciated that the computer readable media described above may be transitory (e.g. a propagating signal) or non-transitory (e.g. embodied in a register, memory, or hard disk), and may be implemented within the object, for example in DSP 464 or memory 432 described below with respect to FIG. 4, or external to the object, for example on a compact disc or external drive.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Referring to FIG. 4, a block diagram of a particular illustrative embodiment of an object corresponding to test point 104 located in a first area, area 100, the object configured as a wireless device, is illustrated, and generally designated 104. The device 104 includes a digital signal processor (DSP) 464 which may be configured to perform the functions described with regard to FIGS. 1A-3B for determining AOAs and RTTs from signal sources, and eventually computing 2D velocity estimates according to exemplary embodiments. For example, DSP 464 may be configured to perform any or all of the Blocks 306, 310, 312, and/or 314 illustrated in FIG. 3A or any or all of the Blocks 352-358 illustrated in FIG. 3B. DSP 464 may be coupled to memory 432. Databases comprising AOAs, RTTs, and/or LOSs as described above may be included in memory 432, whereby DSP 464 may obtain these values from memory 432 to compute 2D velocity estimates, or may obtain these values through computation, for example based on exchanged communications for RTTs and/or maps or obstacles for AOAs and/or LOSs.

FIG. 4 also shows display controller 426 that is coupled to DSP 464 and to display 428. Coder/decoder (CODEC) 434 (e.g., an audio and/or voice CODEC) can be coupled to DSP 464. Other components, such as wireless controller 440 (which may include a modem) are also illustrated. Speaker 436 and microphone 438 can be coupled to CODEC 434. FIG. 4 also indicates that wireless controller 440 can be coupled to wireless antenna 442. In a particular embodiment, DSP 464, display controller 426, memory 432, CODEC 434, and wireless controller 440 are included in a system-in-package or system-on-chip device 422.

In one embodiment, wireless antenna 442 can be configured as a receiver and comprise logic/means to receive signals from two or more signal sources. Further, wireless antenna 442, in conjunction with wireless controller 440 and DSP 464 can comprise logic/means to determine RTTs of the signals to device 104 and logic/means to determine AOAs of the signals to device 104. DSP 464 can further comprise logic/means to determine delta RTT values of the signals to device 104, based at least in part on relocation of device 104 within the first area and logic/means to calculate a 2D velocity estimate of device 104, based on the delta RTT values and the AOAs.

In a particular embodiment, input device 430 is coupled to the system-on-chip device 422. Moreover, in a particular embodiment, as illustrated in FIG. 4, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-on-chip device 422, such as an interface or a controller.

It should be noted that although FIG. 4 depicts an embodiment wherein test point 104 is configured as a wireless communications device, DSP 464 and memory 432 may also be integrated into a set-top box, a music player, a video player, an entertainment unit, a navigation device, a personal digital assistant (PDA), a fixed location data unit, or a computer. A processor (e.g., DSP 464) may also be integrated into such a device. In some embodiments, FIG. 4 may illustrate elements of a signal source, such as an AP or other signal source, that is configured to transmit signals to the wireless communications device and/or store a database comprising RTTs and/or AOAs. Those of skill in the art will appreciate that certain elements may be omitted, for example one or more of the elements 426-438.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of two-dimensional (2D) velocity estimation of an object located in a first area, the method comprising:
determining round trip times (RTTs) of signals from two or more signal sources to the object;
determining delta RTT values of the signals subsequent to relocation of the object within the first area, based at least in part on the determined RTTs;
determining angles of arrival (AOAs) of the signals at the object; and
calculating a 2D velocity estimate based on the delta RTT values and the AOAs.

2. The method of claim 1, wherein determining the RTTs and the AOAs for the object comprises:
determining in advance, the RTTs and AOAs for a plurality of locations in the first area;
storing the determined RTTs and AOAs in a database; and
looking up the RTTs and the AOAs for the object from the database based on a location of the object in the first area.

3. The method of claim 1, wherein the object is a device comprising a particle filter.

4. The method of claim 1, wherein the object is a mobile device, and determining the RTTs and AOAs are performed in real time in the mobile device based on a floor plan of the first area.

5. The method of claim 1, wherein the object is located at a first height in the first area, and wherein determining the RTTs and AOAs are based on projections of the first height on a two dimensional map of the first area.

6. The method of claim 1, wherein a signal path to the object from a first signal source of the two or more signal sources is obstructed, and wherein the method further comprises:
determining a plurality of line of sight (LOS) paths from the object to the first signal source based on the obstruction;
determining a last LOS path from the plurality of LOS paths;
locating a virtual signal source at a point on the last LOS path; and
replacing the first signal source with the virtual signal source in determining the RTT and AOA for the first signal source.

7. The method of claim 1, wherein calculating the 2D velocity estimate based on the delta RTT values and the AOAs comprises:
representing the 2D velocity as a speed part and an angle part;
determining 1D speed estimates corresponding to the two or more signal sources based on the delta RTT values;
forming a system of non-linear equations comprising the speed part and the angle part relative to projections of the 1D speed estimates and the corresponding AOAs;
solving the system of non-linear equations to calculate the speed part and the angle part; and
determining the 2D velocity from the calculated speed part and angle part.

8. The method of claim 7, wherein the system of non-linear equations is solved using one of the Levenberg-Marquardt algorithm or the Scaled Conjugate Gradients algorithm.

9. The method of claim 1, wherein the first area corresponds to an indoor environment.

10. The method of claim 1, wherein the first area corresponds to an outdoor environment.

11. An apparatus comprising:
a receiver configured to receive signals;
logic to determine round trip times (RTTs) of signals to an object located in a first area from two or more signal sources;
logic to determine delta RTT values of the signals to the object based at least in part on a relocation of the object within the first area and the determined RTTs;
logic to determine angles of arrival (AOAs) of the signals at the object; and
logic to calculate a 2D velocity estimate of the object based on the delta RTT values and the AOAs.

12. The apparatus of claim 11, further comprising:
a database configured to store RTTs and AOAs for a plurality of locations in the first area; and
logic configured to look up the RTTs and the AOAs for the object from the database based on a location of the object in the first area.

13. The apparatus of claim 11, wherein the object comprises a particle filter.

14. The apparatus of claim 11, wherein the object is a mobile device configured to determine the RTTs and AOAs in real time based on a floor plan of the first area.

15. The apparatus of claim 11, wherein the object is located at a first height in the first area, and wherein determining the RTTs and AOAs are based on projections of the first height on a two dimensional map of the first area.

16. The apparatus of claim 11, wherein a signal path to the object from a first signal source of the two or more signal sources is obstructed, and wherein the apparatus further comprises:
a plurality of line of sight (LOS) paths from the object to the first signal source based on the obstruction;
logic to determine a last LOS path from the plurality of LOS paths;
logic to determine a virtual signal source located at a point on the last LOS path; and
logic configured to determine the RTT and AOA of the virtual signal source as the RTT and AOA of the first signal source.

17. The apparatus of claim 11, wherein at least the logic is integrated in at least one semiconductor die.

18. The apparatus of claim 11, wherein the first area corresponds to an indoor environment.

19. The apparatus of claim 11, wherein the first area corresponds to an outdoor environment.

20. A system comprising:
means for determining round trip times (RTTs) of signals from two or more signal sources to an object located in a first area;
means for determining delta RTT values of the signals subsequent to relocation of the object within the first area, based at least in part on the determined RTTs;
means for determining angles of arrival (AOAs) of the signals at the object; and
means for calculating a 2D velocity estimate of the object based on the delta RTT values and the AOAs.

21. The system of claim 20, wherein the means for determining the RTTs and the means for determining the AOAs for the object comprises:
means for determining in advance, the RTTs and AOAs for a plurality of locations in the first area;
means for storing the determined RTTs and AOAs; and
means for looking up the RTTs and the AOAs for the object from the means for storing, based on a location of the object in the first area.

22. The system of claim 20, wherein the object is a device comprising a particle filter.

23. The system of claim 20, wherein the object is a mobile device, and wherein the means for determining the RTTs and AOAs are integrated in the mobile device and comprise means for determining the RTTs and AOAs in real time in the mobile device based on a floor plan of the first area.

24. The system of claim 20, wherein the object is located at a first height in the first area, and wherein the means for determining the RTTs and AOAs comprises means for determining the RTTs and AOAs based on projections of the first height on a two dimensional map of the first area.

25. The system of claim 20, wherein a signal path to the object from a first signal source of the two or more signal sources is obstructed, and wherein the system further comprises:
means for determining a plurality of line of sight (LOS) paths from the object to the first signal source based on the obstruction;
means for determining a last LOS path from the plurality of LOS paths;
means for determining a virtual signal source located at a point on the last LOS path; and
means for determining the RTT and AOA of the virtual signal source as the RTT and AOA of the first signal source.

26. The system of claim 20, wherein the means for calculating the 2D velocity estimate based on the delta RTT values and the AOAs comprises:
means for representing the 2D velocity as a speed part and an angle part;
means for determining 1D speed estimates corresponding to the two or more signal sources based on the delta RTT values;
means for forming a system of non-linear equations comprising the speed part and the angle part relative to projections of the 1D speed estimates and the corresponding AOAs;
means for solving the system of non-linear equations to calculate the speed part and the angle part; and
means for determining the 2D velocity from the calculated speed part and angle part.

27. The system of claim 20, wherein the first area corresponds to an indoor environment.

28. The system of claim 20, wherein the first area corresponds to an outdoor environment.

29. A non-transitory computer-readable storage medium comprising code, which, when executed by a processor, causes the processor to perform operations for estimating two-dimensional (2D) velocity of an object located in a first area, the non-transitory computer-readable storage medium comprising:
code for determining round trip times (RTTs) of signals from two or more signal sources to the object;
code for determining delta RTT values of the signals subsequent to relocation of the object within the first area, based at least in part on the determined RTTs;
code for determining angles of arrival (AOAs) of the signals at the object; and
code for calculating a 2D velocity estimate based on the delta RTT values and the AOAs.

30. A method for speed estimation comprising:
determining at least two linearly-independent one dimensional (1D) speed measurements based on signals from a plurality of access points (APs);
measuring angles of arrival (AOAs) for each of the signals; and
calculating a two dimensional (2D) velocity estimate using the at least two linearly-independent 1D speed measurements and the AOAs for each of the signals.
